(19) United States
(12) Patent Application Publication
(10) Pub. No.: US 2015/0247097 A1
(43) Pub. Date: Sep. 3, 2015

(54) ABOVE-GROUND STORAGE TANKS WITH INTERNAL HEAT SOURCE AND METHODS AND SYSTEMS FOR PROCESSING PRODUCED FLUIDS

(71) Applicant: ENVIROVAULT CORPORATION, Calgary (CA)

(72) Inventor: Russell HEBBLETHWAITE, Cochrane (CA)

(73) Assignee: ENVIROVAULT CORPORATION, Calgary (CA)

(21) Appl. No.: 14/675,210

(22) Filed: Mar. 31, 2015

Related U.S. Application Data
(62) Division of application No. 12/964,951, filed on Dec. 10, 2010.

(30) Foreign Application Priority Data
Dec. 10, 2009 (CA) 2687818

(51) Int. Cl. C10G 31/06; B01D 17/02

(52) U.S. Cl. CPC C10G 31/06; B01D 17/0214

(57) ABSTRACT

A method of oil water phase separation through heat using a flameless heat source in an above ground process tank with the desired separation level of 0.5% basic sediment and water remaining in the oil. The tank having a flameless heat source installed within an internal chamber inside the tank. The above-ground process tank may form part of a system for processing a produced fluid from a petroleum wellhead upstream of a sales line or tank. An oil pipe network discharges the produced fluid from the wellhead into the tank interior volume. The flameless heat source generates radiant heat in the internal chamber which is conducted by the chamber wall into the tank interior volume to separate the oil phase from the water phase of an emulsion in the produced fluid. The oil pipe network discharges the separated oil phase from the tank interior volume to the sales line or tank.

### CROSS REFERENCE TO RELATED APPLICATION

This application is a continuation-in-part of U.S. patent application Ser. No. 12/964,951 filed on Dec. 10, 2010 and entitled “Above-Ground Storage Tanks with Internal Heat Source”, the entire contents of which are herein incorporated by reference.

### FIELD OF THE INVENTION

The present invention is directed to above-ground fluid storage tanks with internal containment chambers having a flameless heat source, and to systems and methods for processing a produced fluid from a petroleum wellhead upstream of a sales line.

### BACKGROUND

The storage of materials, including petroleum products and waste materials, in the upstream and downstream petroleum industry is dependent on primary containment devices, such as underground and above-ground storage tanks. Such tanks typically include secondary containment measures, which are required in some jurisdictions.

Many above-ground storage tanks are heated to avoid freezing or to reduce viscosity of the tank contents, which encourages phase separation. For example, petroleum products may be heated to allow for more efficient and economical transport of the produced fluid, and to remove gases and water which can have deleterious effects on transportation and processing equipment.

Conventional tank heating systems utilize burners and firetubes. A firetube typically involves a single pass tube running through the tank interior from an exterior burner assembly. Hot flue gases from the burner pass through the firetube, through the tank, and exit an exterior chimney or stack.

It is not uncommon to have tank fires or explosions where the fluid level in the tank drops below the firetube within the tank. This hazard may be particularly acute when the tank is used to heat petroleum products which may liberate combustible gases when heated. For this reason, certain jurisdictions prohibit the use of open flame equipment within a minimum distance of tanks used to store petroleum products. Burner shutdown switches associated with fluid level floats are expensive installations, and suffer their own failures. In addition to safety concerns, burner and firetube heater assemblies are inefficient, resulting in large energy costs and increased greenhouse gas emissions. Burner management systems (BMS) often need a pilot to start. The pilot is always running, meaning that there is always an open flame on site.

There is a need in the art for above-ground storage tanks with flameless heating systems, and systems and method for processing petroleum products, which may mitigate the problems of the prior art.

### SUMMARY OF THE INVENTION

In one aspect, the invention comprises a system and method of heating an above-ground fluid processing tank, the tank having an interior volume and a containment chamber formed by a containment wall separating the containment chamber from the tank interior volume, the method comprising the steps of using a flameless heat source to heat the containment wall, and conducting heat through the containment wall into the tank interior.

In one embodiment, sufficient heat is conducted into the tank interior volume to achieve separation of emulsified oil and water phases inside the tank interior volume, within a relatively short period of time. The amount of heat may be calculated having regard to a desired temperature of the emulsified oil and water phases and a size of the tank interior volume. The desired goal of separation is conventionally less than 0.5% basic sediment and water remaining in the oil to produce a fungible grade of oil, referred to herein as dry oil.

In another aspect, the invention comprises a system for processing a produced fluid from a petroleum wellhead upstream of a sales line, wherein the produced fluid comprises an oil phase and a water phase, the system comprising:
(a) an oil pipe network comprising an oil pipe inlet in communication with the wellhead and an oil pipe outlet in communication with the sales line; and
(b) a process tank defining a tank interior volume and comprising an internal containment chamber separated from the tank interior volume by a containment wall, and a flameless heat source disposed within the containment chamber, and directed at the containment wall, wherein the containment wall is heated by the flameless heat source and conducts heat to the tank interior volume;
(c) wherein the process tank receives the produced fluid from the oil pipe inlet, discharges oil to the oil pipe outlet, and discharges water to a water outlet.

In one embodiment of the system, the system further comprises a water pipe network for discharging the water phase from the tank interior volume. The oil pipe network may further comprise a free water separator for separating any free water portion from the produced fluid upstream of the above-ground process tank, wherein the free water separator is in communication with the water pipe network for discharging the free water portion, when separated, into the water pipe network. The water pipe network may further comprise a water storage tank for flotation separation of any residual oil in either one or both of the water phase discharged from the tank interior volume or the free water portion discharged from the free water separator. The system may further comprise a residual oil pipe network for discharging the residual oil from the water storage tank to the tank interior volume.

In one embodiment of the system, the oil pipe network further comprises a gas separator for separating any dissolved gas phase from the produced fluid upstream of the above-ground storage tank, wherein the gas separator is in communication with a gas pipe network for discharging the gas phase, when separated, into a fuel gas line inlet of the flameless heat source comprising a catalytic heater.

In another aspect, the invention comprises a method for processing a produced fluid from a petroleum wellhead upstream of a sales line, wherein the produced fluid comprises an oil phase and a water phase, the method comprising the steps of:
(a) supplying the produced fluid from the wellhead to a process tank defining a tank interior volume and comprising an internal containment chamber separated from the tank interior volume by a containment wall;
(b) using a flameless heat source disposed within the containment chamber to heat the containment wall and conducting heat through the containment wall into the tank interior volume to produce dry oil substantially free of water and sediment; and
(c) directing the dry oil to an oil storage tank or the sales line.

In one embodiment of the method, the emulsion is heated to a temperature of at least about 20 degrees Celsius.

In one embodiment of the method, the method comprises the further steps of: discharging the separated water phase from the tank interior volume into a water pipe network comprising a water storage tank. The method may also comprise the further steps of: using a free water separator to separate a free water portion from the produced fluid upstream of the above-ground storage tank; and discharging the separated free water portion from the free water separator into the water pipe network. Either one or both of the water phase discharged from the tank interior volume or the free water portion discharged from the free water separator may be retained in the water storage tank to allow for flotation-separation of any residual oil therein. The flotation-separated residual oil may be then discharged into the tank interior volume.

In one embodiment of the method, the method comprises the further steps of: using a gas separator to separate a dissolved gas phase from the produced fluid upstream of the above-ground storage tank; discharging the separated gas phase into a fuel gas line inlet of the flameless heat source comprising a catalytic heater; and when heating the containment wall, using the catalytic heater to catalyze the separated gas phase to generate heat.

In another aspect, the invention may comprise A fluid storage tank defining an interior volume, and comprising:
(a) an internal chamber defined by a containment wall separating the internal chamber from the tank interior volume, wherein the containment wall comprises a curved wall or a plurality of planar segments; and
(b) a plurality of flameless heat sources, each mounted to and directed at a different portion of the containment wall.

### BRIEF DESCRIPTION OF THE DRAWINGS

In the drawings, like elements are assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention. The drawings are briefly described as follows:

FIG. 1A shows a vertical cross-section through one embodiment of a tank of the present invention. FIG. 1B is a horizontal cross-section of the containment chamber. FIG. 1C shows a horizontal cross-section of an alternative embodiment of the containment chamber

FIG. 2 shows a vertical cross-section through another alternative embodiment, where the containment chamber is raised off the tank floor.

FIG. 3 shows a schematic representation of one embodiment of the system of the present invention used to supply dry oil to a sales line, when the system is set up for a high flow state of produced fluid with a high water content.

FIG. 4 shows a schematic representation of the embodiment of the system of FIG. 3, when the system is set up for a steady-state flow of produced fluid with a low water content.

FIG. 5 shows a schematic representation of an alternative embodiment of a system of the present invention in top plan view.

FIG. 6 shows a schematic representation of the embodiment of FIG. 5.

### DETAILED DESCRIPTION OF PREFERRED EMBODIMENTS

The invention relates to above-ground process tanks. When describing the present invention, all terms not defined herein have their common art-recognized meanings. To the extent that the following description is of a specific embodiment or a particular use of the invention, it is intended to be illustrative only, and not limiting of the claimed invention. The following description is intended to cover all alternatives, modifications and equivalents that are included in the spirit and scope of the invention, as defined in the appended claims.

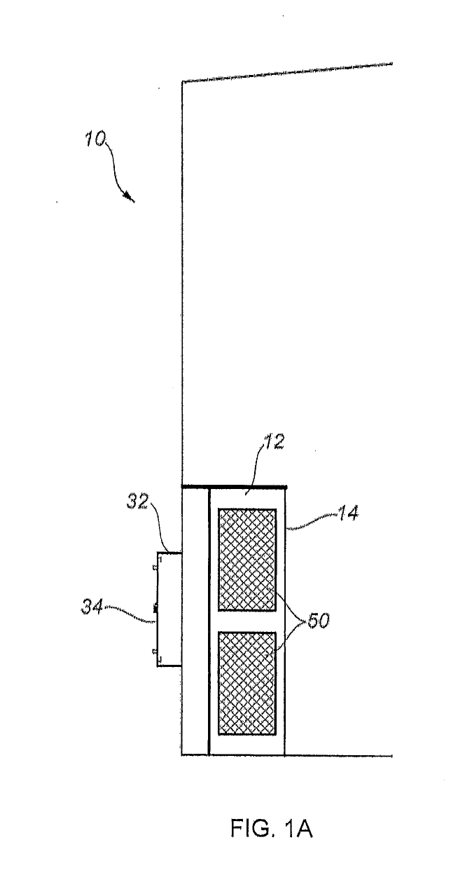

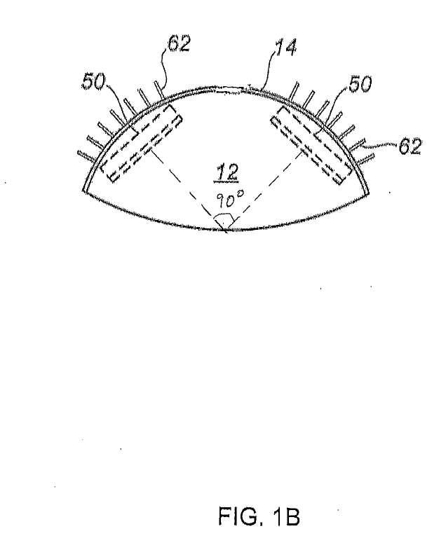

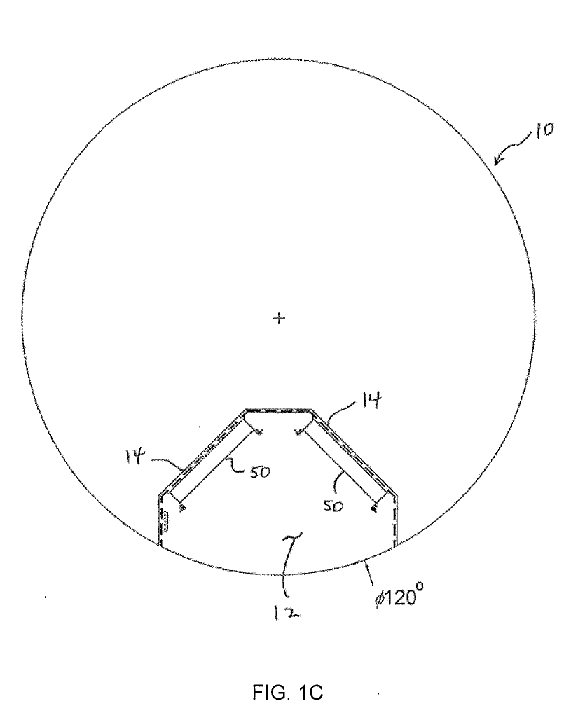

Standard above-ground fluid storage tanks with containment chambers are known. Suitable tanks and chambers are described in Canadian Patent No. 2,196,842, the entire contents of which are incorporated herein by reference, where permitted. FIG. 1A depicts a fluid storage tank (10) having a containment chamber (12), which is defined by containment wall (14) which completely separates the chamber from the interior volume of the tank. A flameless heat source (50) is included within the containment chamber

In one embodiment, the invention comprises an above-ground process tank (10) defining an interior volume and comprising:

(a) a tank roof, a tank floor, and a tank wall;
(b) a containment chamber formed by a containment wall (14), and an exterior door assembly (32, 34);
(c) a flameless heat source (50) disposed within the containment chamber (12) and directed at the containment wall (14).

As used herein, “flameless heat” means heat generated without the rapid oxidation characteristic of fire or combustion. Flameless heat may be generated, for example and without limitation, by chemical reaction, electrical resistance, or magnetic induction. The flameless heat source (50) may comprise a catalytic heater, such as a propane or natural gas powered catalytic heater, which are well known in the industry. Catalytic heaters operate by controlled oxidation of a fuel, at a temperature below the ignition point of the fuel. Suitable catalytic heaters may include Cata-Dyne™ heaters (CCI Thermal Technologies Inc.).

The size and number of heaters (50) contained within the containment chamber may be calculated by one skilled in the art. Once the tank interior volume is known and the desired temperature to be maintained, then one may calculate the heat required. Other factors which may influence the determination of heat required may include the presence or quality of insulation on the tank, the expected range of exterior temperatures where the tank is to be used or installed, and the flow rate of fluids through the tank. The determination of the quantum of heat required is well within the ordinary skill of one skilled in the art without undue experimentation.

For example, one may calculate the heat required for a particular application by considering equations (I) (II) and (III). The heat rate for fluid is expressed in Btu per hour.

$$\begin{matrix}{\dot{m}}_{water} = \frac{{\dot{v}}_{total}}{24} \times WC \times {ρ}_{water} & ( I ) \\ {\dot{m}}_{oil} = \frac{{\dot{v}}_{total}}{24} \times ( 1 - WC ) \times {ρ}_{oil} & ( II ) \\ {\dot{q}}_{fluid} = ( {\dot{m}}_{water} \times {c}_{ρ , water} + {\dot{m}}_{oil} \times {c}_{ρ , oil} ) \times ( {T}_{outlet} \times {T}_{inlet} ) & ( III )\end{matrix}$$

### Where:

| Variable | Symbol | Units |
|---|---|---|
| Total Fluid Rate | \dot{ν}_{water} | bbl/day |
| Water Cut | WC | % |
| Density of Water | ρ_{water} | lb/bbl |
| Density of Oil | ρₒᵢₗ | lb/bbl |
| Water Mass Flow Rate | \dot{m}_{water} | lb/hr |
| Oil Mass Flow Rate | \dot{m}ₒᵢₗ | lb/hr |
| Specific Heat Capacity of Water | c_{p, water} | Btu/(lb ° F.) |
| Specific Heat Capacity of Oil | c_{p, oil} | Btu/(lb ° F.) |
| Inlet Temperature | Tᵢₙₗₑₜ | ° F. |
| Outlet Temperature | Tₒᵤₜₗₑₜ | ° F. |
| Heat Rate for Fluid | \dot{q}_{fluid} | Btu/hr |

The heat rate for fluid is then the total heat required from the heaters:

qₜₒₜₐₗ=nₕₑₐₜₑᵣAₕₑₐₜₑᵣQₕₑₐₜₑᵣ (IV)

where:

qₜₒₜₐₗ total heat flow from all active heaters (Btu/hr)

nₕₑₐₜₑᵣ number of active heaters

Aₕₑₐₜₑᵣ surface area of each heater (ft²)

Qₕₑₐₜₑᵣ heater heat flux (Btu/hr·ft²)

Therefore, in one example, where a heat rate has been calculated in accordance with equations I-III above, it is desirable to install enough heat capacity (n which is greater than the required heat, so that the heaters are not required to operate continuously at maximum capacity. For example, if the heat rate is calculated to be 180,000 Btu/hour, then 3 heaters each having a surface area of 12 ft² (for a total of 36 ft2) and a heat flux of 5000 Btu/hr per square foot will provide 180,000 Btu/hour.

In one embodiment, particularly with the use of catalytic heaters, the chamber should be adequately ventilated to provide for sufficient oxygen for the catalytic heater to react with the fuel, and secondarily, to prevent excessive heat buildup in the containment chamber itself.

The fuel gas inlet lines for the catalytic heaters may be run into the containment chamber in a conventional fashion, such as through the door assembly, or through the tank wall below the door assembly. Alternative and suitable sources of flameless heat include electric heaters or inductive heat sources.

In one embodiment, the heat source may be regulated by a thermostat or other temperature control, which may be responsive to the air temperature within the containment chamber, or the temperature of the contents of the tank volume, or both.

The containment chamber (12) is differentiated from a conventional firetube in that it does not serve as a conduit for products of combustion, and does not require an inlet and outlet. The containment chamber comprises a discrete and contiguous space disposed substantially within the tank interior volume, and is the heat source for the tank itself.

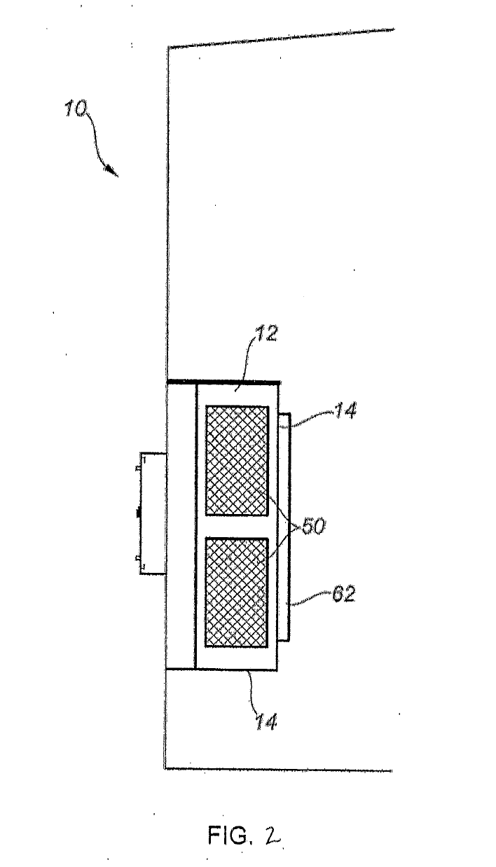

Heat transfer from the containment wall (14), and into the tank interior volume is then by conductive means. The containment chamber would thus heat the fluid within the tank in the immediate vicinity of the containment wall, which would then flow convectively within the tank. In one embodiment, heat radiating fins (62) may be attached to the chamber wall (14), projecting into the tank interior volume. In a further alternative, as shown in FIG. 2, the internal chamber may be raised from the tank floor, providing additional surface area to conduct heat to the tank interior volume.

In one embodiment, a plurality of heaters (50) may be positioned in horizontally adjacent positions along the containment wall (14). As a result, the total area of containment wall which is heated by the heaters increases. In one embodiment, each heater is oriented in a different direction as a result of being mounted to the containment wall (14). As one skilled in will appreciate, the containment wall (14) must be curved or formed from planar segments to form the internal containment chamber. For example, as shown in FIG. 1B, two adjacent heaters are oriented at approximately a 90° angle, as they are mounted to a curved containment wall (14). In another example, as shown in FIG. 1C, a similar configuration may be achieved with 3 or 5 planar segments (14). As the heaters are oriented in different directions, they direct heat into different volumes of the tank contents.

Alternatively, or in addition, heaters (50) may be mounted vertically stacked as shown in FIG. 1A or FIG. 2.

The heated tank (10) as described above may form part of a system for processing a produced fluid from a petroleum wellhead upstream of a sales line. As known by those skilled in the art, such produced fluid typically comprises a mixture of an oil phase and a water phase, a free water portion, and a dissolved gas phase. The produced fluid is heated in the process tank (10) to accelerate phase separation, resulting in dry oil and water substantially free of oil, which may then be separately collected.

The system (100) generally comprises an oil pipe network (110) and a process tank (10). The oil pipe network (110) has an oil pipe inlet (112) and an oil pipe outlet (114). The oil pipe inlet (112) communicates with the wellhead to receive the produced fluid from the wellhead. The oil pipe outlet (112) communicates with a sales line.

In one embodiment, the system (100) further includes a water pipe network (120) that includes at least one water storage tank (122), preferably a second water storage tank (124), and a residual oil pipe network (126). The water pipe network (120) is used to discharge the water phase separated from the produced fluid in the process tank. The water storage tanks (124, 126) are used to remove residual oil from the water phase and the free water portion. The residual oil pipe network (126) is used to discharge the residual oil from the water storage tanks (122, 124), preferably into the process tank (10).

In one embodiment, the system (100) also includes a free water separator (130) in the oil pipe network (110) upstream of the tank (10). The free water separator (130) may be any suitable device known in the art for separating the free water portion from the produced fluid. In one embodiment, the free water separator (130) comprises a free-water knockout (FWKO) vessel as is known in the art. The free water separator (130) is also in communication with the water pipe network (120) to discharge the separated free water into the water pipe network (120) and into the water storage tank (122).

In one embodiment, the system (100) also includes a gas separator (140) in the oil pipe network (110) upstream of the tank (10). The gas separator (140) may be any suitable device known in the art for separating a gas phase from produced fluid. In one embodiment, the gas separator (140) may be an inlet separator disposed at the wellhead for initial bulk separation of the gas phase from the produced fluid, such as a vane-type inlet separator, centrifugal or cyclone-type inlet separator, or mesh-type inlet separator. In another embodiment, the gas separator (140) may be combined with the free water separator (130) and may comprise a free-water knockout (FWKO) vessel. The gas separator (140) is also in communication with a gas pipe network (142) that discharges gas separated by the gas separator (140). In one embodiment, the separated gas may be used as a fuel for a catalytic heater that provides the flameless heat source (50) of the tank (10).

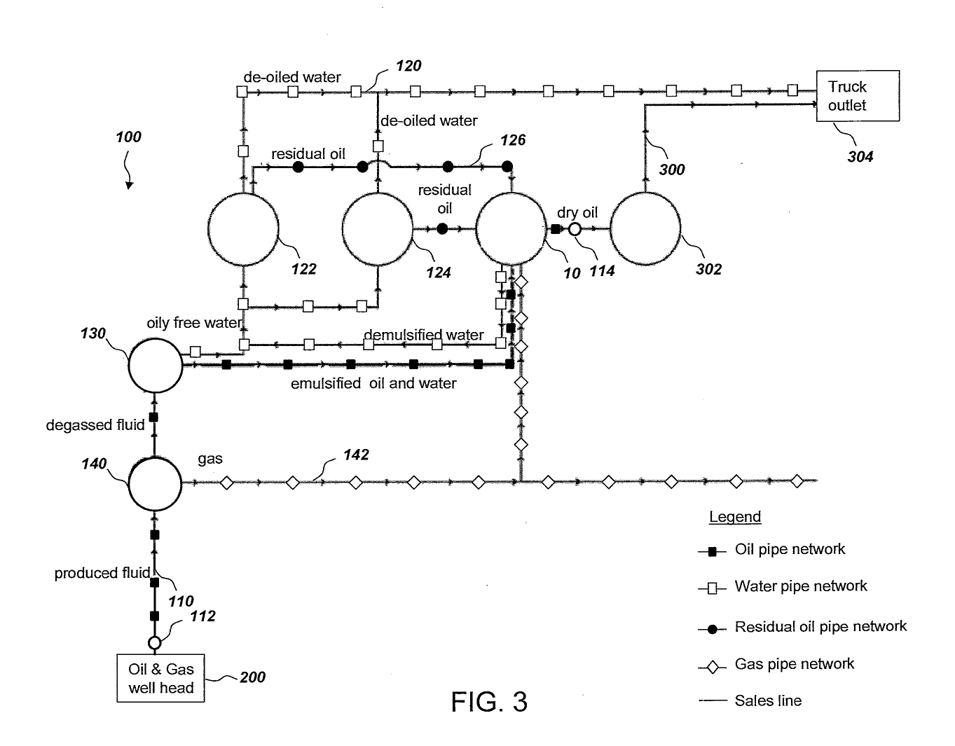

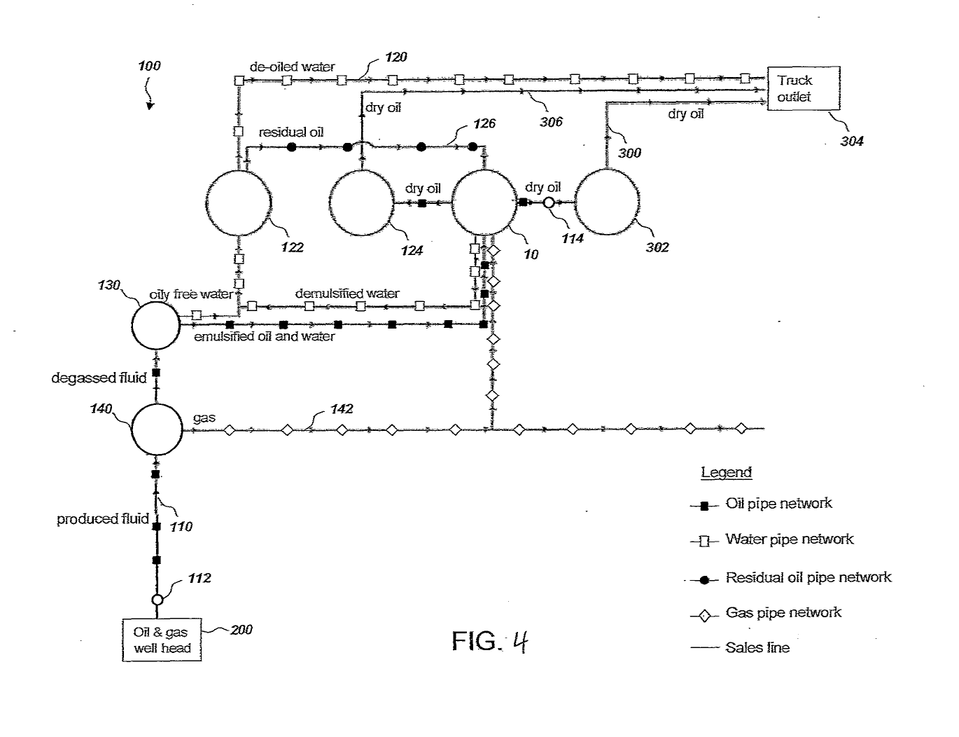

In FIGS. 3 and 4, the arrows in the pipe networks (110, 120, 142) and the sales line (300) indicate the general direction of fluid flow therein.

FIG. 3 shows one embodiment of the system (100) set up for a high flow state of produced fluid from the wellhead (e.g., above 500 barrels of produced fluid a day, such as in the range of about 1000 barrels of produced fluid per day) with a high water content (e.g. above 50%, such as in the range of about 66 percent). The produced fluid from the wellhead flows into the oil pipe network (110) at oil pipe inlet (112) and to the gas separator (140). The gas separator (140) separates the gas phase from the produced fluid and diverts the gas phase into the gas pipe network (142). Separation of the gas phase prior to heating the produced fluid may reduce the safety risks associated with heating the produced fluid.

The produced fluid that emerges from the gas separator (140), labeled as “degassed fluid” in FIG. 3, continues to flow into the oil pipe network (110) to the free water separator (130). The free water separator (130) separates the free water portion from the produced fluid. The separated free water portion is labeled as “oily free water” in FIG. 3.

That portion of the produced fluid that emerges from the free water separator (130) comprises the emulsion of the water phase and the oil phase, and is labeled in FIG. 3 as the “emulsified water and oil”. The emulsified water and oil continues to flow in the oil pipe network (110) and into the tank interior volume of tank (10). As described above, the flameless heat source (50) is used to heat the containment wall (14). In one embodiment where the flameless heat source (50) comprises a catalytic heater, the gas phase separated by the gas separator (140) may flow in the gas pipe network (142) into a fuel gas inlet for the catalytic heater so that the gas phase may be catalyzed to produce heat. Use of this gas phase rather than an external gas source to generate the heat may reduce the overall energy requirements of the system.

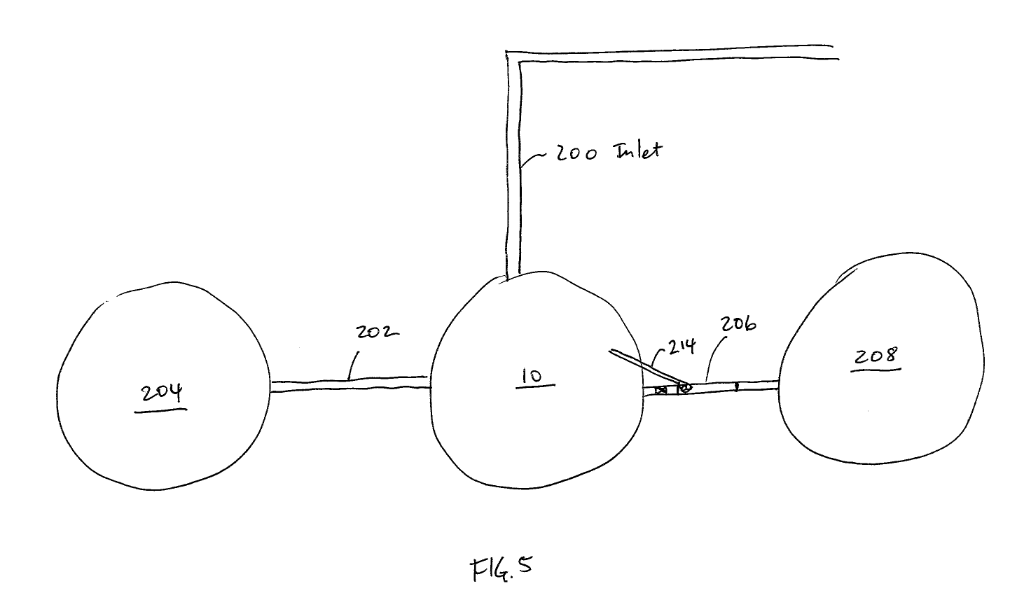

The heated containment wall (14) conducts heat into the tank interior volume, thus reducing the viscosity of the emulsified oil and water and heating thereby accelerating phase separation. The flameless heat source (50) and the containment wall (14) are configured such that sufficient heat is conducted into the tank interior volume to accelerate separation of the emulsified oil and water into its constituent water phase, labeled as “demulsified water” in FIG. 3, and its oil phase, labeled as “dry oil” in FIG. 5. This breaking of the emulsion can be desirable in that the dry oil has a lower thermal capacity and requires less heat to increase and maintain its temperature for transport and processing, and may have less deleterious effects on transport and processing equipment, as compared with the unprocessed produced fluid. The amount of heat required to accelerate breaking of the emulsion can be selected without undue experimentation by persons of ordinary skill in the art having regard to a variety of factors related to the system (100) (such as the desired temperature, the size of the tank interior volume, the residence time of the produced fluid in the tank interior volume) and factors affecting the stability of the emulsion (such as the composition, concentration and size of hydrocarbon components and inorganic solids, the acidity of the water components, and the presence of any demulsifying agents in the produced fluid). In one embodiment, the flameless heat source is capable of heating the produced fluids in the tank to a desired temperature, even in winter conditions where the outside temperatures may be below freezing. For example, the desired temperature of at least about 20 degrees Celsius, preferably at least about 30 degrees Celsius, and more preferably at least about 40 degrees Celsius.

As the oily free water and the demulsified water separated by the tank (10) may still contain residual oil, it may be desirable to de-oil the oily free water and the demulsified water prior to re-use and discharge into the environment. Accordingly, the oily free water and the demulsified water flow in the water pipe network (120) into the two water storage tanks (122, 124) and retained therein for a suitable amount of time as may be determined by persons of ordinary skill in the art, to allow for flotation separation of the residual oil from the water components to produce “de-oiled water” as labeled in FIG. 3. Alternative methods of oil water separation are known in the art and may be used in place of flotation separation. The separated “residual oil”, as labeled in FIG. 5 is then removed from the water storage tanks (122, 124) using suitable means know in the art (for example, an overflow weir) and allowed to flow through the residual oil pipe network (126) back into the oil pipe network (110). In one embodiment as shown in FIG. 5, the residual oil is returned directly to the process tank (10). It will be appreciated that insofar as the residual oil may itself comprise emulsified water, continuous operation of the system (100) will allow for cycling of emulsified oil and water between the tank (10) and the water storage tanks (122, 124), resulting in incremental de-watering of the residual oil, and de-oiling of the demulsified water with each cycle. The de-oiled water continues to flow in the water pipe network (120) where it may be further transported to another location for re-use or discharged into a tanker truck at a truck outlet (304).

The oil phase separated in the tank (10) is a fungible grade of oil, labeled as “dry oil” in FIG. 3, flows in the oil pipe network (110) through to the oil pipe outlet (114). The oil pipe outlet (114) discharges the dry oil into the sales line (300) where it may be temporarily stored in a sales oil tank (302) before being further transported by pipeline or discharged into a tanker truck at the truck outlet (304).

FIG. 4 shows the embodiment of the system (100) of FIG. 3 set up for a steady-state flow of produced fluid from the wellhead (e.g., less than about 500 barrels a day, such as in the range of about 150 barrels of produced fluid per day) with a relatively low water content (e.g. less than about 50%, such as in the range of about 20-30%). The system (100) is substantially the same as shown in FIG. 5, except that the storage tank (124) is used to store dry oil rather than for flotation separation of residual oil. It will be appreciated by those of ordinary skill in the art that the modified use of the storage tank (124) can be effected through suitable means such as pipes and valves to selectively close off the branch of the water pipe network (120) that feeds oily free water and demulsified water into the tank (124), to selectively allow for the dry oil to discharge from tank (10) into the tank (124), and to selectively allow for flow of the dry oil from the tank (124) into the same sales line (300) or a secondary sales line (306) as shown in FIG. 4.

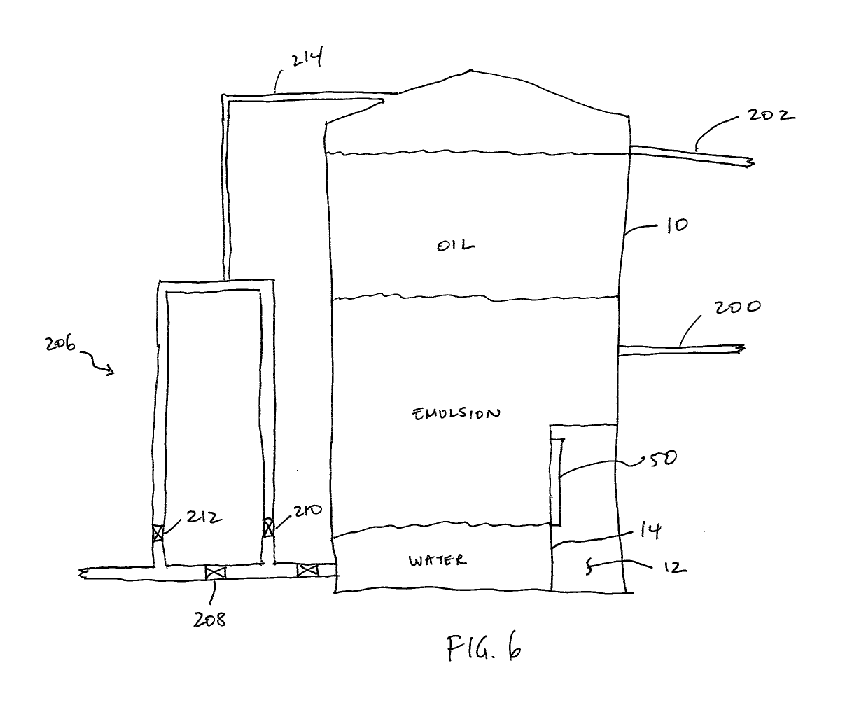

In an alternative embodiment, shown in FIGS. 5 and 6, the produced fluids are directly introduced to the process tank (10) which is heated internally through a containment wall (14) by a flameless heater (50) as described above. The produced fluids enter though an inlet (200) at a rate which permits sufficient residence time in the process tank to achieve adequate phase separation of the emulsified phases. Free water accumulates at the bottom of the tank, while substantially dry oil floats to the top and is skimmed off the top and passes through a spillover pipe (202) to a dry oil tank (204).

Water which accumulates at the bottom of the tank passes through a water leg (206) and into a water tank (208). The height of the water leg may be chosen to approximate the height of the emulsion in the process tank. As may be appreciated by those skilled in the art, if valve (208) is closed and valves (210 and 212) are open, water will pass upwards into the water leg (206) and stream into the water tank if the fluid level in the process tank (210) is above the height of the water leg (206). A vent pipe (214) connects the water leg to the headspace in the process tank (10).

As will be apparent to those skilled in the art, various modifications, adaptations and variations of the foregoing specific disclosure can be made without departing from the scope of the invention claimed herein.

What is claimed is:

2. A system for processing a produced fluid from a petroleum wellhead upstream of a sales line, wherein the produced fluid comprises an oil phase and a water phase, the system comprising:
(a) an oil pipe network comprising an oil pipe inlet in communication with the wellhead and an oil pipe outlet in communication with the sales line; and
(b) a process tank defining a tank interior volume and comprising an internal containment chamber separated from the tank interior volume by a containment wall, and a flameless heat source disposed within the containment chamber, and directed at the containment wall, wherein the containment wall is heated by the flameless heat source and conducts heat to the tank interior volume;
(c) wherein the process tank receives the produced fluid from the oil pipe inlet, discharges oil to the oil pipe outlet, and discharges water to a water outlet.

3. The system of claim 1 further comprising a water pipe network comprising a water storage tank for separation of a residual oil from the water phase discharged from the tank interior volume.

4. The system of claim 3 further comprising a residual oil pipe network for discharging the residual oil, when separated from the water phase, from the water storage tank back to the process tank.

5. The system of claim 1 wherein the oil pipe network further comprises a free water separator for separating a free water portion from the produced fluid upstream of the process tank, wherein the free water separator is in communication with the water pipe network for discharging the free water portion, when separated, into the water pipe network.

6. The system of claim 4 wherein the water pipe network further comprises a water storage tank for flotation separation of a residual oil from the free water portion discharged from the free water separator supply

7. The system of claim 5 further comprising a residual oil pipe network for discharging the residual oil, when flotation-separated from the free water portion, from the water storage tank to the tank interior volume.

8. The system of claim 1 wherein the oil pipe network further comprises a gas separator for separating a dissolved gas phase from the produced fluid upstream of the process tank.

9. The system of claim 7 wherein the gas separator is in communication with a gas pipe network for discharging the gas phase, when separated, into a fuel gas line inlet of the flameless heat source comprising a catalytic heater.

10. A method for processing a produced fluid from a petroleum wellhead upstream of a sales line, wherein the produced fluid comprises an oil phase and a water phase, the method comprising the steps of:
(a) supplying the produced fluid from the wellhead to a process tank defining a tank interior volume and comprising an internal containment chamber separated from the tank interior volume by a containment wall;
(b) using a flameless heat source disposed within the containment chamber to heat the containment wall and conducting heat through the containment wall into the tank interior volume to produce dry oil substantially free of water and sediment; and
(c) directing the dry oil to an oil storage tank or the sales line.

11. The method of claim 9 wherein the emulsion is heated to a temperature of at least about 20 degrees Celsius.

12. The method of claim 9 comprising the further step of discharging a separated water phase from the process tank into a water pipe network.

13. The method of claim 11 further comprising the steps of:
(a) allowing for separation of any residual oil from the discharged water phase; and
(b) discharging the flotation-separated residual oil into the process tank.

14. The method of claim 11 further comprising the steps of:
(a) separating a free water portion from the produced fluid upstream of the process tank;
(b) allowing for separation of any residual oil from the free water portion; and
(c) discharging the flotation-separated residual oil into the process tank.

15. The method of claim 9 further comprising the further steps of:
(a) separating a dissolved gas phase from the produced fluid upstream of the process tank;
(b) discharging the separated gas phase into a fuel gas line inlet of the flameless heat source comprising a catalytic heater; and
(c) when heating the containment wall, using the catalytic heater to catalyze the separated gas phase to generate heat.

16. The method of claim 9 wherein the flameless heat source is configured to direct a calculated amount of heat to the containment wall to achieve a desired temperature or a desired rate of separation within the tank interior volume.

17. A fluid storage tank defining an interior volume, and comprising:
(a) an internal chamber defined by a containment wall separating the internal chamber from the tank interior volume, wherein the containment wall comprises a curved wall or a plurality of planar segments; and
(b) a plurality of flameless heat sources, each mounted to and directed at a different portion of the containment wall.

18. The fluid storage tank of claim 16 wherein the containment wall comprises a curved wall and the plurality of flameless heat sources are mounted horizontally adjacent to each other.

19. The fluid storage tank of claim 16 wherein the containment wall comprises a planar segmented wall and each of the flameless heat sources are mounted on a different planar segment.

20. The fluid storage tank of claim 16 wherein the flameless heat sources are mounted to the containment wall in a vertically stacked configuration.
